(19) United States
(12) Patent Application Publication
(10) Pub. No.: US 2005/0095947 A1
(43) Pub. Date: May 5, 2005

(54) Field emission display device and driving method thereof

(75) Inventor: Seong Hak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/976,858

(22) Filed: Nov. 1, 2004

(30) Foreign Application Priority Data
Nov. 5, 2003 (KR) 078025/2003

(51) Int. Cl. H01J 9/12; H01J 9/04

(52) U.S. Cl. 445/51; 445/50

(57) ABSTRACT

An FED device and its driving method prevent distortion of electron beams generated from an FED device. The FED device includes an insulation layer formed on at least one or more gate electrodes; and a focus electrode formed on the insulation layer.

### BACKGROUND OF THE INVENTION

1. Field of the Invention

The present invention relates to a field emission display (FED) and, more particularly, to an FED device and its driving method.

2. Description of the Prior Art

Recently, as information communication techniques are rapidly advanced, demands for a display is increasing and the structure of the display varies. For example, in an environment requiring mobility, a display with a light, small volume and low power consumption such as a mobile information communication device is required, while when a display is used as a general information transfer medium, the display is to have a large screen such as a CRT (Cathode Ray Tube), an LCD (Liquid Crystal Display), a PDP (Plasma Display Panel), a VGD (Vacuum Fluorescent Display). Accordingly, development of an FED that can provide high resolution as well as reduce a size and power consumption is ongoing actively.

The FED receives an attention as a flat panel display for next-generation information and communication that overcomes shortcomings of a currently developed or mass-produced flat panel displays (e.g., an LCD, a PDP, a VFD, etc.). The FED device has many advantages that its electrode structure is simple, it can be operated at a high speed like the CR and has an infinite color, an infinite gray scale and high luminance.

Lately, an FED device having a carbon nano tube is commonly used. The carbon nano tube is mechanically strong and chemically stable and has excellent electron emission characteristics at a low degree of vacuum. The carbon nano tube has a small diameter (about 1.0˜ scores of nm) to have an excellent field enhancement factor compared to an emitter having a micro tip, so that it can emit an electron by a low turn-on field (about 1˜5V/μm). In addition, by applying the carbon nano tube to the FED device, a power loss and a production unit cost of the FED device can be reduced.

The structure of the FED device having the carbon nano tube will now be described with reference to FIG. 1.

FIG. 1 is a sectional view showing the structure of an FED device having a carbon nano tube in accordance with a conventional art.

As shown in FIG. 1, the FED device having a carbon nano tube includes: an anode electrode 21 formed on an upper glass substrate 20; a phosphor layer 22 formed on the anode electrode 21; a cathode electrode 12 and a gate electrode 11 formed on the same plane of the lower glass substrate 10; and a carbon nano tube 13 formed on a portion of the cathode electrode 12. The cathode electrode 12 and the gate electrode 11 are formed on the same plane of the lower glass substrate.

When a high voltage is applied to the anode electrode 21 and then a threshold voltage is applied to the gate electrode 11 and the cathode electrode 12, electrons (electron beam) generated from an edge of the carbon nano tube 13 formed on the cathode electrode 12 are bent in the direction of the gate electrode 11 and emitted in the direction of the anode electrode. The electrons emitted in the direction of the anode electrode are accelerated by the high voltage that has been applied to the anode electrode 21 to collide with the phosphor layer 22 formed on the anode electrode 21. At this time, the phosphor layer 22 is excited by the electron beam to emit visible rays.

However, the electron beam emitted from the carbon nano tube 13 can be distorted when it is emitted in the direction of the anode electrode, and if the electron beam is distorted, a cross talk occurs between adjacent cells and contract of an image deteriorates.

In addition, since electron beam is emitted only to a portion of the phosphor layer 22 due to the distortion of electron beam emitted from the carbon nano tube 13, uniformity of a screen is degraded. In particular, the general FED device uses electron beam generated only at an edge of one side of the carbon nano tube, electron beam is bent only in one direction, failing to excite the entire surface of the phosphor layer 22, and thus, since only a portion of the phosphor layer 22 is excited, luminance and uniformity are degraded.

As mentioned above, the conventional FED device having the carbon nano tube has many problems as follows.

That is, since the gate electrode and the cathode electrode are separately disposed, the carbon nano tube formed on the cathode electrode and electron beam is emitted only from an edge of the carbon nano tube, luminance is degraded, and since the distorted electron beam reaches the phosphor layer, a cross talk is generated between neighboring cells.

In addition, since the distorted electron beam excites only a portion of the phosphor layer, uniformity of the screen is degraded.

The FED device is also disclosed in U.S. Pat. Nos. 6,169,372, 6,646,282 and 6,672,926.

### SUMMARY OF THE INVENTION

Therefore, one object of the present invention is to provide an FED (Field Emission Display) device and its driving method capable of preventing distortion of electron beam generated from an FED device.

Another object of the present invention is to provide an FED device and its driving method capable of enhancing luminance of an FED.

Still another object of the present invention is to provide an FED device and its driving method capable of preventing a cross talk between neighboring cells of an FED.

To achieve these and other advantages and in accordance with the purpose of the present invention, as embodied and broadly described herein, there is provided an FED device including an insulation layer formed on at least one or more gate electrodes; and a focus electrode formed on the insulation layer.

To achieve the above objects, there is also provided an FED device including: cathode electrodes formed on a cathode electrode line; carbon nano tubes formed on the cathode electrodes; a gate electrode formed between the carbon nano tubes; a first insulation layer formed on the gate electrode; and a focus electrode formed on the insulation layer.

To achieve the above objects, there is also provided an FED device including: a cathode electrode line formed on a lower glass substrate; a first insulation layer formed on the cathode electrode line; a gate electrode positioned at the center of the FED device (cell) and formed on the first insulation layer; a first cathode electrode formed on the first insulation layer and electrically connected to the cathode electrode line; a second cathode electrode formed in the first insulation layer and electrically connected to the cathode electrode line; a first carbon nano tube formed on the first cathode electrode; a second carbon nano tube formed on the second cathode electrode; a second insulation layer formed on the gate electrode; and a focus electrode formed on the second insulation layer.

To achieve the above objects, there is also provided an FED device having an anode electrode formed on an upper glass substrate, a phosphor layer formed on the anode electrode, a cathode electrode line formed on a lower glass substrate, a first insulation layer formed on the cathode electrode line, a gate electrode positioned at the center of the FED (cell) and formed on the first insulation layer, a first cathode electrode electrically connected with a cathode electrode line exposed through a first via hole formed at the first insulation layer and formed in the first via hole, a second cathode electrode electrically connected with a cathode electrode line exposed through a second via hole formed at the first insulation layer and formed in the second via hole, a first carbon nano tube formed on the first cathode electrode and a second carbon nano tube formed on the second cathode electrode, including: a second insulation layer formed on the gate electrode; and a focus electrode formed on the second insulation layer.

To achieve the above objects, there is also provided a method for driving an FED device having cathode electrodes, a gate electrode, an insulation layer formed on the gate electrode and a focus electrode formed on the insulation layer, including: a step in which when the FED device is driven, a higher positive voltage than a voltage applied to the cathode electrodes is applied to the gate electrode; and a step in which when the FED device is driven, a lower positive voltage than a voltage applied to the gate electrode is applied to the cathode electrodes.

To achieve the above objects, there is also provided a method for driving an FED device having cathode electrodes formed on a cathode electrode line, carbon nano tubes formed on the cathode electrodes, a gate electrode formed between the carbon nano tubes, a first insulation layer formed on the gate electrode, and a focus electrode formed on the insulation layer, including: a step in which when the FED device is driven, a higher positive voltage than a voltage applied to the cathode electrodes is applied to the gate electrode; a step in which when the FED device is driven, a lower positive voltage than a voltage applied to the gate electrode is applied to the cathode electrodes; and a step in which when the FED device is driven, a higher focus voltage than the voltage applied to the gate electrode is applied to the focus electrode.

To achieve the above objects, there is also provided a method for driving an FED device having an anode electrode formed on an upper glass substrate, a phosphor layer formed on the anode electrode, a cathode electrode line formed on a lower glass substrate, a first insulation layer formed on the cathode electrode line, a gate electrode positioned at the center of the FED (cell) and formed on the first insulation layer, a first cathode electrode electrically connected with a cathode electrode line exposed through a first via hole formed at the first insulation layer and formed in the first via hole, a second cathode electrode electrically connected with a cathode electrode line exposed through a second via hole formed at the first insulation layer and formed in the second via hole, a first carbon nano tube formed on the first cathode electrode; a second carbon nano tube formed on the second cathode electrode: a second insulation layer formed on the gate electrode; and a focus electrode formed on the second insulation layer, including: a step in which when the FED device is driven, a higher positive voltage than a voltage applied to the cathode electrodes is applied to the gate electrode; a step in which when the FED device is driven, a lower positive voltage than a voltage applied to the gate electrode is applied to the cathode electrodes; a step in which when the FED device is driven, a higher focus voltage than the voltage applied to the gate electrode is applied to the focus electrode; a step in which when the FED device is not driven, a higher positive voltage than the voltage applied to the gate electrode is applied to the cathode electrodes; and a step in which a higher voltage than the voltage applied to the gate electrode is applied to the cathode electrode during at least one of periods during which the FED device is not driven.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing the structure of an FED device having a carbon nano tube in accordance with a conventional art;

FIG. 2 is a sectional view showing the structure of an FED device in accordance with a preferred embodiment of the present invention;

FIG. 3 shows voltage waveforms in a method for driving the FED device in accordance with a first embodiment of the present invention;

FIG. 4 shows voltage waveforms in a method for driving the FED device in accordance with a second embodiment of the present invention; and

FIG. 5 is a conceptual view showing the FED device and the driving method in accordance with the first and second embodiment of the present invention.

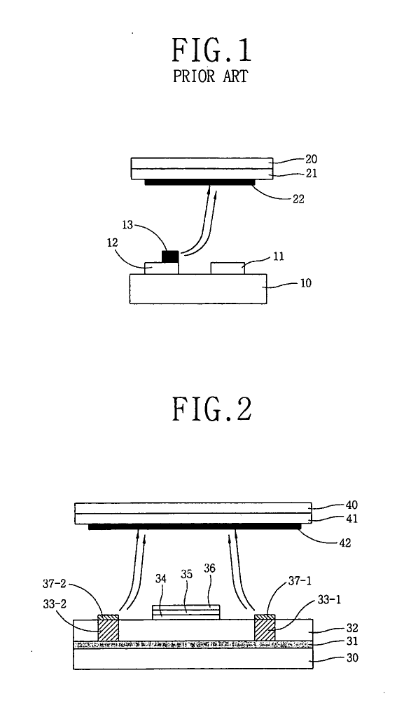

### DETAILED DESCRIPTION OF THE PREFERRED EMBODIMENTS

An FED device capable of preventing distortion of generated electron beam, enhancing luminance and preventing a cross talk between neighboring cells by forming an insulation layer on at least one gate electrode and a focus electrode on the insulation layer and its driving method in accordance with preferred embodiments of the present invention will now be described with reference to FIGS. 2 to 5.

FIG. 2 is a sectional view showing the structure of an FED device in accordance with a preferred embodiment of the present invention.

As shown in FIG. 2, an FED device in accordance with the present invention includes: an anode electrode 41 formed on an upper glass substrate 40; a phosphor layer 42 formed on the anode electrode 41; a cathode electrode line 31 formed on a lower glass substrate 30; a first insulation layer 32 formed on the cathode electrode line 31; a gate electrode 34 positioned at the center of the FED (cell) and formed on the first insulation layer 32; a second insulation layer 35 formed on the gate electrode 34; a focus electrode 36 formed on the second insulation layer 35; a first cathode electrode 33-1 electrically connected with a cathode electrode line exposed through a first via hole formed at the first insulation layer 32 and formed in the first via hole; a second cathode electrode 33-2 electrically connected with a cathode electrode line exposed through a second via hole formed at the first insulation layer 32 and formed in the second via hole; a first carbon nano tube 37-1 formed on the first cathode electrode 33-1; and a second carbon nano tube 37-2 formed on the second cathode electrode 33-2.

The gate electrode 34 is formed between the first carbon nano tube 37-1 and the second carbon nano tube 37-2. The carbon nano tubes 37-1 and 37-2 can be changed to various structures.

The structure of the FED device in accordance with the present invention will now be described in detail.

First, the cathode electrode line 31 is positioned on the lower glass substrate 30 and the first insulation layer 32 is positioned on the cathode electrode line 31. The gate electrode 34 is disposed at the center of the cell (the FED device) of the first insulation layer 32.

The first cathode electrode 33-1 is formed in the first via hole of the first insulation layer 3 and the second cathode electrode 33-2 is formed in the second via hole of the first insulation layer 32. Thus, preferably, the first and second cathode electrodes 33-1 and 33-2 have the same thickness as the first insulation layer 32. In addition, after the first and second cathode electrodes 33-1 and 33-2 are formed in the first and second via holes, preferably, the first and second cathode electrodes 33-1 and 33-2 are smoothed.

The first and second carbon nano tubes 37-1 and 37-2 are formed at the same plane of the gate electrode 34. For example, the first and second carbon nano tubes 37-1 and 37-2 are formed on the first and second cathode electrodes 33-1 and 33-2 formed in the first and second via holes of the first insulation layer 3. In this case, the first and second cathode electrodes 33-1 and 33-2 are electrically connected with the cathode electrode line 31 exposed by the first and second via holes.

The second insulation layer 35 is formed on the gate electrode 34 positioned at the center of the FED device (cell), and the focus electrode 36 is formed on the second insulation layer 35.

The second insulation layer 35 can be thicker than the first insulation layer 32. Namely, the focus electrode 36 is formed higher than the first and second carbon nano tubes 37-1 and 37-2.

When a focus voltage is applied to the focus electrode 36, electron beams generated from the first and second carbon nano tubes 37-1 and 37-2 are induced in the direction of the anode electrode, so that the electron beam does not spread or be distorted.

The operation of the FED device in accordance with the present invention will now be described.

First, the first and second carbon nano tubes 37-1 and 37-2 are formed at the left and right side of the gate electrode 34 to increase electrons generated from edges of the first and second carbon nano tubes 37-1 and 37-2. The increased electrons (electron beams) are bent in the direction of the gate electrode positioned at the center of the cell (FED device) to collide with the phosphor layer 42. The entire surface of the phosphor layer 42 is excited by the electron beams to emit visible rays.

The electron beams generated from the first and second carbon nano tubes 37-1 and 37-2 have a parabolic locus by being bent in the direction of the gate electrode, so that the entire area of the phosphor layer 42 is excited, uniformity of the screen can be enhanced and luminance can better. In addition, since the electron beams are bent in the direction of the gate electrode positioned at the center of the cell and emitted in the direction of the anode electrode, a cross talk does not occur between neighboring cells.

By forming the focus electrode 36 at the upper portion of the gate electrode 34, electrons emitted by the gate electrode 34 can be induced in the direction of the anode electrode by the focus electrode 36. Accordingly, the electron beams does not spread and focused on the phosphor layer 42 and thus distortion of the electron beams can be prevented. For example, by applying a higher pulse voltage than a pulse voltage applied to the gate electrode 34, (e.g., during a device driving period), the electron beams are focused on the phosphor layer 42 and distortion of the electron beams can be prevented.

In addition, when the FED device is driven, in order to increase the amount of emission of electrons emitted from the carbon nano tube formed on the cathode electrode, a higher voltage than a voltage applied to the cathode electrode is applied to the gate electrode. Meanwhile, when the FED device is not driven, a higher voltage than the voltage applied to the gate electrode is applied to the cathode electrode so that electrons cannot be emitted due to a high voltage applied by the carbon nano tubes formed on the cathode electrodes to the anode electrode to prevent generation of dark current. Namely, a phenomenon that electrons are unnecessarily emitted due to a dark current to unnecessarily radiate the phosphor layer can be prevented.

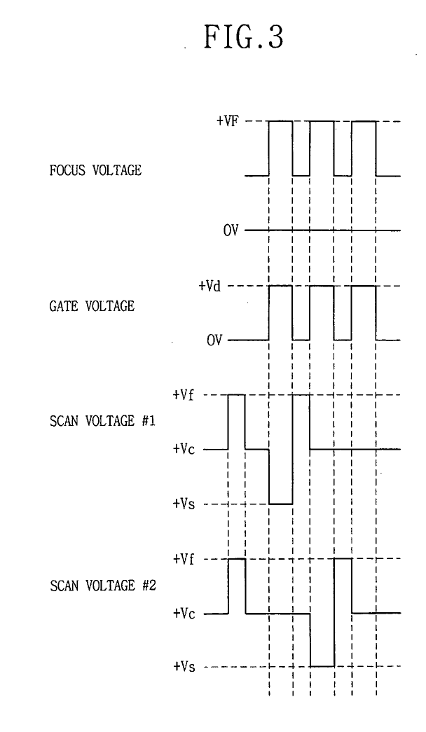

A method for driving the FED device in accordance with a first embodiment of the present invention will now be described with reference to FIG. 3.

FIG. 3 shows voltage waveforms in a method for driving the FED device in accordance with a first embodiment of the present invention, showing waveforms of voltages applied to the cathode electrodes 33-1 and 33-2 (scan lines), the gate electrode 34 (data line) and the focus electrode 36.

It is assumed that the FED devices are disposed in a lattice form and driven in a matrix driving method. Herein, the FED includes a plurality of scan lines (cathode electrode) and data liens (gate electrode), and in this respect, one gate electrode 34, one focus electrode 36 and two cathode electrodes 33-1 and 33-2 are taken as examples.

As shown in FIG. 3, when the FED device in accordance with the present invention is driven, on the basis of the gate voltage (+Vd) applied to the gate electrode 34, a focus voltage (+VF) higher than the gate voltage (+Vd) is applied in a pulse form to the focus electrode 36. In this respect, the focus voltage +VF can be applied in a pulse voltage form or a DC voltage form to the focus electrode 36, but in order to lower current consumption, it is preferred that the focus voltage is applied in the pulse form to the focus electrode 36.

The gate electrode +Vd is applied to the gate electrode 34 when a scan voltage (#1) applied to the cathode electrodes 33-1 and 33-2 is a ground voltage (+Vs) (i.e., 0V) during a period that the FED device is driven, and the gate voltage (+Vd) is selectively applied to the gate electrode 34 according to existence or non-existence of data. The gate voltage (+Vd) applied to the gate electrode 34 is a voltage for driving the FED device, which is lower than the focus voltage (+VF). Preferably, +Vs is the ground voltage or a low positive voltage.

The scan voltage (#1) applied to the cathode electrodes 33-1 and 33-2 before the FED device is driven and a scan voltage (#2) applied to cathode electrodes adjacent to the cathode electrodes 33-1 and 33-2 are a higher voltage (Vf) than the ground voltage Vs and a reference voltage Vc. Preferably, the higher voltage Vf is as high as the focus voltage (+VF) and is an arbitrary voltage higher than the gate voltage (+Vd) applied to the gate electrode 34.

A method for applying the focus voltage and the gate voltage according to the scan voltage (#1) applied to the cathode electrodes 33-1 and 33-2 will now be described.

First, the scan voltage applied to the cathode electrodes 33-1 and 33-2 is a voltage (+Vf) higher than the voltage applied to the gate electrode 34, which is applied to the cathode electrodes 33-1 and 33-2 for a predetermined time in order to prevent a dark current before the FED device is driven.

Thereafter, while the reference voltage (+Vc) greater than the gate voltage (+Vd) applied to the gate electrode 34 is continuously applied to the cathode electrodes 33-1 and 33-2, when a corresponding FED device is selected, the ground voltage (+Vs) is applied to the cathode electrodes 33-1 and 33-2 during a driving period.

When the driving period ends, the gate voltage (+Vd) becomes a ground potential and the focus voltage (VF) is also lowered to the gate voltage (+Vd). Thus, in order to prevent the dark current generated by the electric field between the first and second carbon nano tubes 37-1 and 37-2 formed on the cathode electrodes 33-1 and 33-2 and the anode electrode 41, it is preferred that the higher voltage (+Vf) than the voltage applied to the gate electrode 34 is applied to the cathode electrodes 33-1 and 33-2 during a silent period.

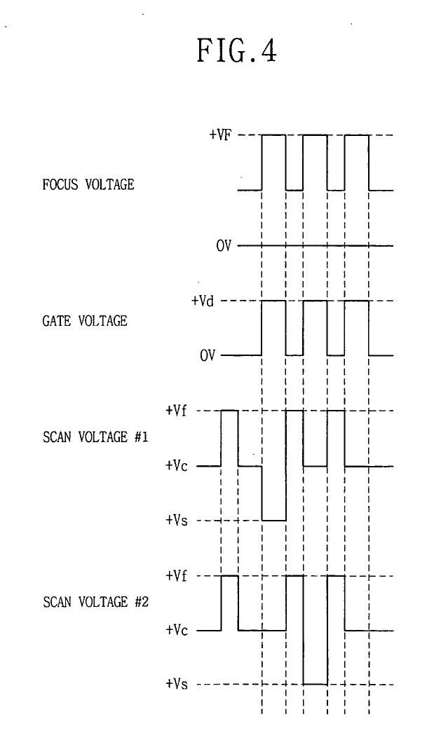

FIG. 4 shows voltage waveforms in a method for driving the FED device in accordance with a second embodiment of the present invention.

As shown in FIG. 4, as the scan electrode applied to the cathode electrodes 33-1 and 33-2, the higher voltage (+Vf) than the gate voltage applied to the gate electrode 34 is applied to the cathode electrodes 33-1 and 33-2 at every silent period between the device driving periods, so that the dark current can be effectively prevented and contrast of the FED can be enhanced, while power consumption is a little bit increased compared to the first embodiment of the present invention.

In addition, during the period of driving the FED device, the gate voltage (+Vd) higher than the positive voltage (+Vs) applied to the cathode electrodes 33-1 and 33-2 is applied to the gate electrode 34, and the focus voltage (+VF) higher than the gate voltage (+Vd) is applied to the focus electrode 36 to thereby increase the amount of electron discharge and prevent distortion of electron beams.

During the period in which the FED device is not driven, the voltage (+Vc and +Vf) higher than the gate voltage (+Vd) applied to the gate electrode 34 is applied to the cathode electrodes 33-1 and 33-2 to thereby prevent the dark current and improve contrast of the FED.

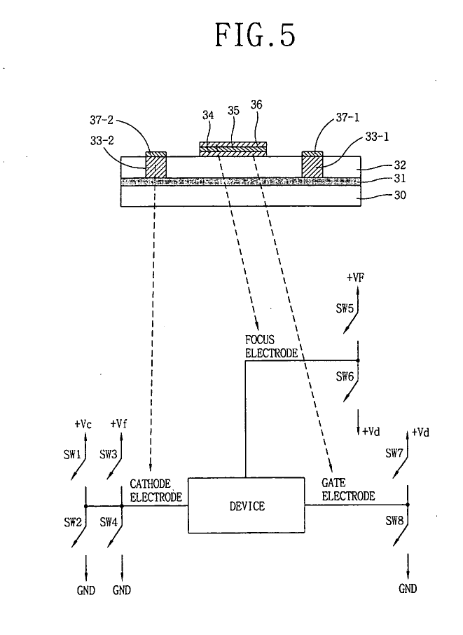

FIG. 5 is a conceptual view showing the FED device and the driving method in accordance with the first and second embodiment of the present invention.

First, voltages that can be applied to the cathode electrodes 33-1 and 33-2 include the ground voltage (+Vs) and the voltages (+Vc and +Vc) greater than the ground voltage (+Vs), which are the same as or greater than the ground voltage. Namely, in order to prevent generation of the dark current and distortion of the electron beams, it is preferred to apply the positive voltage to the cathode electrodes 33-1 and 33-2.

In addition, the reference voltage (+Vc) of the scan voltage is higher than the gate voltage (+Vd) applied to the gate electrode 34, and in order to shield electric field generated by the anode electrode 41, the focus voltage (+VF) greater than the voltage applied to the cathode electrodes 33-1 and 33-2 is applied to the focus electrode 36. Namely, after the reference voltage (+Vc) is applied to the cathode electrodes 33-1 and 33-2, in order to shield electric field generated by the anode electrode 41, the high voltage (+Vf) is applied to the cathode electrodes 33-1 and 33-2, and in order to drive the FED device, the ground voltage (+Vs) is applied to the cathode electrodes 33-1 and 33-2.

The focus voltage (+VF) for shielding the electric field generated by the anode electrode 41 and focusing electron beams is always applied to the focus electrode 36. In this case, preferably, the focus voltage (+VF) is applied to the focus electrode 36 in synchronization with the gate voltage (+Vd).

When the FED device is driven, the gate voltage (+Vd) or the ground voltage (0V) is applied to the gate electrode 34 according to existence or non-existence of data, and the gate voltage (+Vd) is so high as to drive the FED device when the ground voltage is applied to the cathode electrodes 33-1 and 33-2.

The FED device can be driven through various methods other than the methods shown in FIGS. 3 to 5, and the driving methods as shown in FIG. 3 to 5 can be modified variably.

Basically, in order to collect electron beams of the FED device on the phosphor layer 42, when the FED device is driven, preferably, a voltage greater than the voltage applied to the cathode electrodes 33-1 and 33-2 is applied to the gate electrode 34 and a voltage smaller than the voltage applied to the gate electrode 34 is applied to the cathode electrodes 33-1 and 33-2.

In order to prevent distortion of electron beams of the FED device and induce the electron beams in the direction of the anode electrode, when the FED device is driven, preferably, the focus electrode 36 is formed at a position higher than the carbon nano tubes 37-1 and 37-2 and the focus voltage higher than the voltage applied to the gate electrode 34 is applied to the focus electrode 36.

In order to enhance contrast of the FED by preventing generation of the dark current, when the FED device is not driven, preferably, a voltage greater than the voltage applied to the gate electrode 34 is applied to the cathode electrodes 33-1 and 33-2.

In order to enhance contrast of the FED by effectively preventing the dark current, preferably, a voltage higher than the voltage applied to the gate electrode 34 is applied to the cathode electrodes 33-1 and 33-2 during one of periods during which the FED device is not driven.

As so far described, the FED device in accordance with the present invention has many advantages as follows.

That is, for example, first, since the gate electrode is formed at the center of the FED device, the cathode electrodes are formed at the left and right side of the gate electrode and the carbon nano tubes are formed on the cathode electrodes, electron beams generated from the carbon nano tubes can be focused in the direction of the gate electrode.

Second, since the plurality of electron beams generated from the carbon nano tubes are emitted on the phosphor layer of the FED by being bent in the direction of the gate electrode positioned at the center of the FED device, a cross talk between neighboring cells can be prevented and luminance can be enhanced. For example, while the FED device is not driven, a voltage greater than the voltage applied to the gate electrode is applied to the cathode electrodes, thereby preventing the cross talk between neighboring cells and enhancing the luminance.

Third, since the cathode electrodes are formed in the FED device and then the gate electrode is formed between the cathode electrodes, narrowing the interval between the gate electrode and each cathode electrode, so that a driving voltage of the FED device can be lowered.

Fourth, since the gate electrode, the insulation layer and the focus electrode are sequentially formed at the center of the FED device and then the voltage higher than the voltage applied to the gate electrode is applied to the focus electrode, electric field generated by the anode electrode can be shielded. Thus, generation of a dark current and distortion of electron beams can be prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An FED device comprising:
an insulation layer formed on at least one or more gate electrodes; and
a focus electrode formed on the insulation layer.

2. An FED device comprising:
cathode electrodes formed on a cathode electrode line;
carbon nano tubes formed on the cathode electrodes;
a gate electrode formed between the carbon nano tubes;
a first insulation layer formed on the gate electrode; and
a focus electrode formed on the insulation layer.

3. The device of claim 2, wherein each cathode electrode is formed by filling a conductive material in a via hole formed at a second insulation layer positioned on the cathode electrode line.

4. The device of clam 3, wherein the thickness of each cathode electrode is the same as that of the second insulation layer.

5. The device of claim 4, wherein the height of the focus electrode is greater than the height of each carbon nano tube.

6. An FED device comprising:
a cathode electrode line formed on a lower glass substrate;
a first insulation layer formed on the cathode electrode line;
a gate electrode positioned at the center of the FED device (cell) and formed on the first insulation layer;
a first cathode electrode formed on the first insulation layer and electrically connected to the cathode electrode line;
a second cathode electrode formed in the first insulation layer and electrically connected to the cathode electrode line;
a first carbon nano tube formed on the first cathode electrode;
a second carbon nano tube formed on the second cathode electrode; a second insulation layer formed on the gate electrode; and
a focus electrode formed on the second insulation layer.

7. The device of claim 6, wherein the height of the focus electrode is greater than the height of the first and second carbon nano tubes.

8. An FED device having an anode electrode formed on an upper glass substrate, a phosphor layer formed on the anode electrode, a cathode electrode line formed on a lower glass substrate, a first insulation layer formed on the cathode electrode line, a gate electrode positioned at the center of the FED (cell) and formed on the first insulation layer, a first cathode electrode electrically connected with a cathode electrode line exposed through a first via hole formed at the first insulation layer and formed in the first via hole, a second cathode electrode electrically connected with a cathode electrode line exposed through a second via hole formed at the first insulation layer and formed in the second via hole, a first carbon nano tube formed on the first cathode electrode and a second carbon nano tube formed on the second cathode electrode, comprising:
a second insulation layer formed on the gate electrode; and
a focus electrode formed on the second insulation layer.

9. The device of claim 8, wherein the height of the focus electrode is greater than the height of each carbon nano tube.

10. A method for driving an FED device having cathode electrodes, a gate electrode, an insulation layer formed on the gate electrode and a focus electrode formed on the insulation layer, comprising:
a step in which when the FED device is driven, a higher positive voltage than a voltage applied to the cathode electrodes is applied to the gate electrode; and
a step in which when the FED device is driven, a lower positive voltage than a voltage applied to the gate electrode is applied to the cathode electrodes.

11. The method of claim 10, further comprising:
a step in which when the FED device is not driven, a focus voltage higher than the voltage applied to the gate electrode is applied to the focus electrode.

12. The method of claim 10, wherein when the FED device is not driven, a positive voltage greater than the voltage applied to the gate electrode is applied to the cathode electrodes.

13. The method of claim 10, wherein when the FED device is not driven, a voltage pulse higher than the voltage applied to the gate electrode is applied to the cathode electrodes, and when the FED device is driven, a low positive voltage or a ground voltage is applied to the cathode electrodes.

14. The method of claim 10, further comprising:
a step in which a voltage higher than the voltage applied to the gate electrode is applied to the cathode electrode during one of periods during which the FED device is not driven.

15. The method of claim 11, wherein the focus voltage is a DC voltage or a pulse voltage.

16. A method for driving an FED device having cathode electrodes formed on a cathode electrode line, carbon nano tubes formed on the cathode electrodes, a gate electrode formed between the carbon nano tubes, a first insulation layer formed on the gate electrode, and a focus electrode formed on the insulation layer, comprising:
a step in which when the FED device is driven, a higher positive voltage than a voltage applied to the cathode electrodes is applied to the gate electrode;
a step in which when the FED device is driven, a lower positive voltage than a voltage applied to the gate electrode is applied to the cathode electrodes; and
a step in which when the FED device is driven, a higher focus voltage than the voltage applied to the gate electrode is applied to the focus electrode.

17. The method of claim 16, wherein when the FED device is not driven, a positive voltage greater than the voltage applied to the gate electrode is applied to the cathode electrodes.

18. The method of claim 16, wherein when the FED device is not driven, a voltage pulse higher than the voltage applied to the gate electrode is applied to the cathode electrodes, and when the FED device is driven, a low positive voltage or a ground voltage is applied to the cathode electrodes.

19. The method of claim 16, further comprising:
a step in which a voltage higher than the voltage applied to the gate electrode is applied to the cathode electrode during one of periods during which the FED device is not driven.

20. A method for driving an FED device having an anode electrode formed on an upper glass substrate, a phosphor layer formed on the anode electrode, a cathode electrode line formed on a lower glass substrate, a first insulation layer formed on the cathode electrode line, a gate electrode positioned at the center of the FED (cell) and formed on the first insulation layer, a first cathode electrode electrically connected with a cathode electrode line exposed through a first via hole formed at the first insulation layer and formed in the first via hole, a second cathode electrode electrically connected with a cathode electrode line exposed through a second via hole formed at the first insulation layer and formed in the second via hole, a first carbon nano tube formed on the first cathode electrode; a second carbon nano tube formed on the second cathode electrode: a second insulation layer formed on the gate electrode; and a focus electrode formed on the second insulation layer, comprising:
a step in which when the FED device is driven, a higher positive voltage than a voltage applied to the cathode electrodes is applied to the gate electrode;
a step in which when the FED device is driven, a lower positive voltage than a voltage applied to the gate electrode is applied to the cathode electrodes;
a step in which when the FED device is driven, a higher focus voltage than the voltage applied to the gate electrode is applied to the focus electrode;
a step in which when the FED device is not driven, a higher positive voltage than the voltage applied to the gate electrode is applied to the cathode electrodes; and
a step in which a higher positive voltage than the voltage applied to the gate electrode is applied to the cathode electrode during at least one of periods during which the FED device is not driven.
